(19) United States
(12) Patent Application Publication
(10) Pub. No.: US 2012/0089756 A1
(43) Pub. Date: Apr. 12, 2012

(54) NETWORK-ATTACHED STORAGE AND METHOD OF CONFIGURING NETWORK-ATTACHED STORAGE

(76) Inventors: Chih-Wen Lu, Pingtung County (TW); Chao-Yin Liu, Hsinchu City (TW); Hua-Shih Liao, Hsinchu City (TW)

(21) Appl. No.: 13/022,608

(22) Filed: Feb. 7, 2011

(30) Foreign Application Priority Data
Oct. 8, 2010 (TW) 099134444

(51) Int. Cl. G06F 13/38

(52) U.S. Cl. 710/74

(57) ABSTRACT

When a NAS apparatus is directly connected to a network and an external apparatus simultaneously, the external apparatus is able to access the NAS apparatus, and the NAS apparatus concurrently communicates with the network for executing a specific function. A method of configuring the NAS apparatus includes: allocating a first storage unit in the NAS apparatus; and setting an attribute of the first storage unit such that the first storage unit is allowed to be read by the NAS apparatus or the external apparatus, and written by the NAS apparatus or the external apparatus.

### BACKGROUND OF THE INVENTION

1. Field of the Invention

The invention relates to a network-attached storage (NAS) apparatus, and more particularly, to a NAS apparatus and a method of configuring a NAS apparatus.

2. Description of the Prior Art

Typically, network-attached storage (NAS) apparatus are used to share or store data in a network. However, conventional NAS apparatus requires a connection to a personal computer (PC) to be accessed via a network, which leads to enormous inconvenience. Recently, a new type of NAS apparatus has appeared in the market, which can be connected directly to the network to perform specific functions (e.g., peer-to-peer transmission function) and perform reading/writing for a memory within the NAS apparatus. In this way, the NAS apparatus can perform the specific functions continuously without a direct connection within a PC.

When the aforementioned NAS apparatus requires to be directly connected to a PC (for example: when executing a software or a file downloaded via the peer-to-peer transmission function), the NAS apparatus must be disconnected from the network to be directly connected to the PC via an interface such as a universal serial bus (USB) or IEEE 1394, etc.; similarly, when the NAS apparatus requires to be re-connected to the network, the NAS apparatus must be disconnected from the PC, and can then build a connection with the network. Please refer to FIG. 1, which is a diagram of a conventional NAS apparatus 100 directly connecting to a network 200 and an external apparatus 300. As shown in the figure, the conventional NAS apparatus 100 includes a storage apparatus 110. If the conventional NAS apparatus 100 is connected to the network 200 and the external apparatus 300 simultaneously, the conventional NAS apparatus 100 and the external apparatus 300 might access the storage apparatus 110 in the conventional NAS apparatus 100 concurrently. In this way, the data in the storage apparatus 110 might be abnormal, resulting in an error.

Therefore, for an access method of the conventional NAS apparatus and a configuration of internal storage interface, there is still much to be improved.

### SUMMARY OF THE INVENTION

To fix the aforementioned problems, the present invention provides a network-attached storage (NAS) apparatus and a method of configuring a NAS apparatus. The NAS apparatus can be directly connected to an external apparatus and a network simultaneously by configuring a storage unit in the NAS apparatus, and the storage unit can be accessed by the external apparatus and the network simultaneously.

According to an embodiment of the present invention, a method of configuring a network-attached storage (NAS) apparatus is provided. When the NAS apparatus is directly connected to a network and an external apparatus simultaneously, the external apparatus is able to access the NAS apparatus, and the NAS apparatus concurrently communicates with the network for executing a specific function. The method includes: allocating at least a first storage unit in the NAS apparatus; and setting an attribute of the first storage unit such that the first storage unit is allowed to be read by the NAS apparatus or the external apparatus, and written by the NAS apparatus or the external apparatus.

According to another embodiment of the present invention, a network-attached storage (NAS) apparatus is provided. The NAS apparatus comprises a processing circuit and at least one storage unit. When the NAS apparatus is directly connected to a network and an external apparatus simultaneously, the external apparatus is able to access the NAS apparatus, and the processing circuit concurrently communicates with the network for executing a specific function. The at least one storage unit comprises a first storage unit. The first storage unit has an attribute such that the first storage unit is allowed to be read by the NAS apparatus or the external apparatus, and written by the NAS apparatus or the external apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a conventional network access storage apparatus directly connecting to a network and an external apparatus.

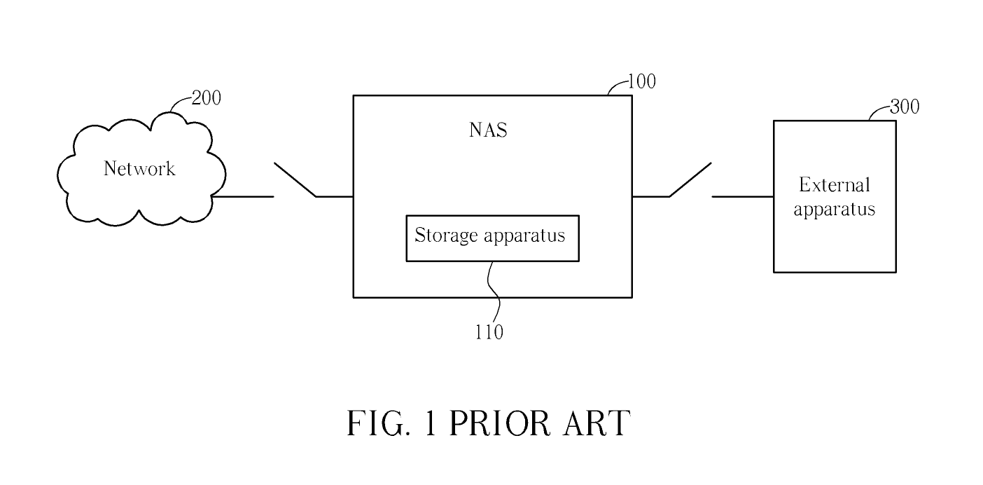

FIG. 2 is a diagram of a network access storage apparatus directly connecting to a network and an external apparatus according to an embodiment of the present invention.

FIG. 3 is an access permission table of virtual discs of different modes corresponding to the network access storage apparatus and the external apparatus according to an embodiment of the present invention.

### DETAILED DESCRIPTION

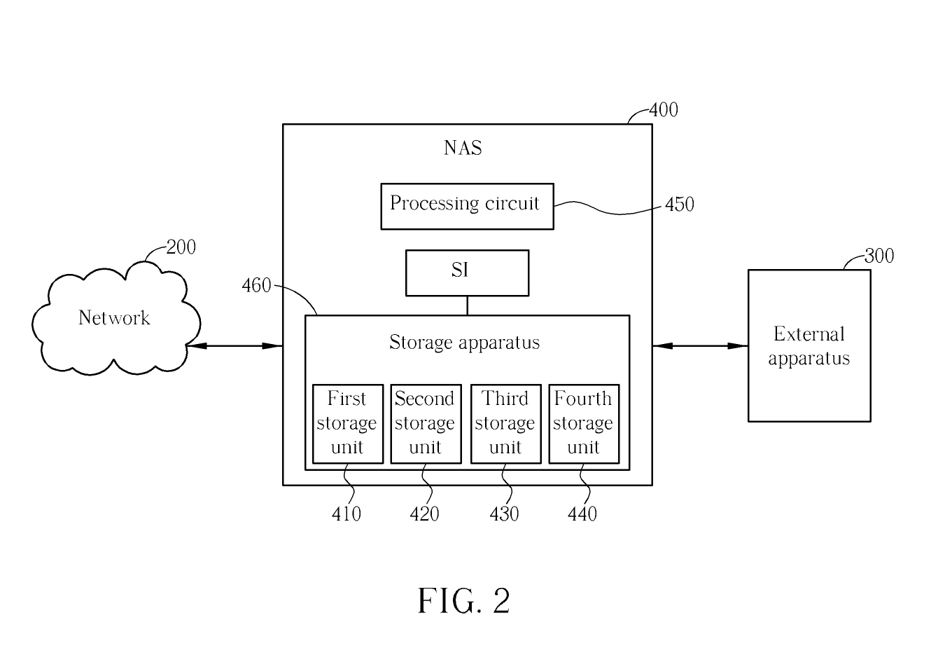

Please refer to FIG. 2, which is a diagram of a NAS apparatus 400 directly connecting to a network 200 and an external apparatus 300 according to the present invention. Please note that the network 200 can be an Ethernet or a wireless local area network (WLAN), and the external apparatus 300 can be a personal computer or a personal digital assistant (PDA), etc., however, these examples are for illustrative purposes only and are not supposed to be limitations to the present invention. In this embodiment, the NAS apparatus 400 includes a storage apparatus 460 and a processing circuit 450. The NAS apparatus 400 has a control software interface SI for controlling an access of the storage apparatus 460; in addition, the storage apparatus 460 includes a first storage unit 410, a second storage unit 420, a third storage unit 430 and a fourth storage unit 440 (please note that the number of storage units shown in FIG. 2 is for illustrative purposes; in practical implementation, the number of allocated storage units in the storage apparatus 460 is not limited to be four), allocated in four different virtual discs derived from the storage apparatus 460, respectively. Those virtual discs, after being set the attributes and authorities thereof, can be read by the NAS apparatus 400 or the external apparatus 300, and be written by the NAS apparatus 400 or the external apparatus 300, respectively.

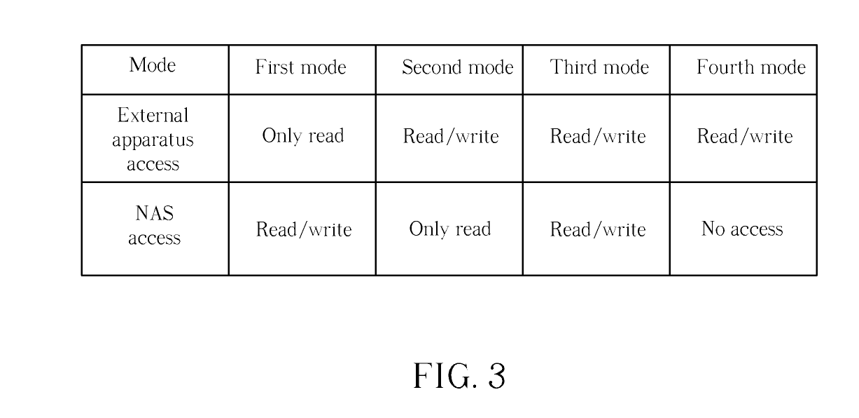

As shown in FIG. 2, when the NAS apparatus 400 is directly connected to the network 200 and the external apparatus 300 simultaneously, the external apparatus 300 can access virtual discs having external access permission in the storage apparatus 460 of the NAS apparatus 400, and the processing circuit 450 can communicate with the network 200 to perform a specific function (for example: network transmission function, peer-to-peer transmission function) simultaneously, and acquire access permission to the other virtual discs (i.e., the first storage unit 410, the second storage unit 420, the third storage unit 430 and the fourth storage unit 440) in the storage apparatus 460. Please refer to FIG. 3, which is an access permission table of virtual discs of different modes corresponding to the NAS apparatus 400 and the external apparatus 300 according to an embodiment of the present invention, wherein the first mode, second mode, third mode and the fourth mode correspond to the first storage unit 410, the second storage unit 420, the third storage unit 430 and the fourth storage unit 440, respectively. As shown in FIG. 3, in the first mode and the second mode, only one of the NAS apparatus 400 and the external apparatus 300 has writing permission to the virtual disc (the first storage unit 410 of the first mode and the second storage unit 420 of the second mode), therefore, those two devices will not perform writing to one identical memory simultaneously, and errors resulting from abnormal data can thereby be avoided.

For the third storage unit 430 of the third mode, when one of the NAS apparatus 400 and the external apparatus 300 is performing writing to the third storage unit 430, the other one of the NAS apparatus 400 and the external apparatus 300 will be disconnected from the third storage unit 430 via the software interface SI. In this way, either the NAS apparatus 400 or the external apparatus 300 can perform writing to the third storage unit 430 without breaking a physical connection between the NAS apparatus 400 and the network 200 or the external apparatus 300. For the fourth mode, the NAS 400 has no access permission to the fourth storage unit 440, and the operation of the fourth storage unit 440 is equivalent to an external hard drive disc to the external apparatus 300.

In addition, when one of the virtual disc is full, the NAS apparatus 400 can still allocate new space for the full virtual disc as long as there is still storage space in the storage apparatus 460, or it extend a space of the full virtual disc via a proper software. In this way, the virtual disc can still be utilized to be written with data.

To summarize, the present invention provides a NAS apparatus and a method of configuring a NAS apparatus. The NAS apparatus can be directly connected to an external apparatus and a network simultaneously by configuring a storage unit in the NAS apparatus, and the storage unit can be accessed by the external apparatus and the network simultaneously.

Those skilled in the art will readily observe that numerous modifications and alterations of the device and method may be made while retaining the teachings of the invention.

What is claimed is:

1. A method of configuring a network-attached storage (NAS) apparatus, wherein when the NAS apparatus is directly connected to a network and an external apparatus simultaneously, the external apparatus is able to access the NAS apparatus, and the NAS apparatus concurrently communicates with the network for executing a specific function, the method comprising:
allocating at least a first storage unit in the NAS apparatus; and
setting an attribute of the first storage unit such that the first storage unit is allowed to be read by the NAS apparatus or the external apparatus, and written by the NAS apparatus or the external apparatus.

2. The method of claim 1, wherein the first storage unit is allowed to be read by the NAS apparatus and the external apparatus, and is only allowed to be written by the NAS apparatus.

3. The method of claim 2, further comprising:
allocating a second storage unit in the NAS apparatus; and
setting an attribute of the second storage unit such that the second storage unit is allowed to be read by the NAS apparatus and the external apparatus, and is only allowed to be written by the external apparatus.

4. The method of claim 2, further comprising:
allocating a second storage unit in the NAS apparatus; and
setting an attribute of the second storage unit such that the second storage unit is allowed to be read by the NAS apparatus and the external apparatus, and is allowed to be written by the NAS apparatus and the external apparatus;
wherein when one of the NAS apparatus and the external apparatus is writing to the second storage unit, a connection between the second storage unit and the other of the NAS apparatus and the external apparatus is disconnected via a software interface.

5. The method of claim 2, further comprising:
allocating a second storage unit in the NAS apparatus; and
setting an attribute of the second storage unit such that the second storage unit is only allowed to be read and written by the external apparatus.

6. The method of claim 1, wherein the specific function executed by the NAS apparatus when the NAS apparatus communicates with the network is a network transmission function.

7. A network-attached storage (NAS) apparatus, comprising:
a processing circuit, wherein when the NAS apparatus is directly connected to a network and an external apparatus simultaneously, the external apparatus is able to access the NAS apparatus, and the processing circuit concurrently communicates with the network for executing a specific function; and
a first storage unit, having an attribute such that the first storage unit is allowed to be read by the NAS apparatus or the external apparatus, and written by the NAS apparatus or the external apparatus.

8. The NAS apparatus of claim 7, wherein the first storage unit is allowed to be read by the NAS apparatus and the external apparatus, and is only allowed to be written by the NAS apparatus.

9. The NAS apparatus of claim 8, further comprising
a second storage unit, having an attribute such that the second storage unit is allowed to be read by the NAS apparatus and the external apparatus, and is only allowed to be written by the external apparatus.

10. The NAS apparatus of claim 8, further comprising:
a second storage unit, having an attribute such that the second storage unit is allowed to be read by the NAS apparatus and the external apparatus, and is allowed to be written by the NAS apparatus and the external apparatus;
wherein when one of the NAS apparatus and the external apparatus is writing to the second storage unit, a connection between the second storage unit and the other of the NAS apparatus and the external apparatus is disconnected via a software interface.

11. The NAS apparatus of claim 8, further comprising:
a second storage unit, having an attribute such that the second storage unit is only allowed to be read and written by the external apparatus.

12. The NAS apparatus of claim 7, wherein the specific function executed by the processing circuit when the processing circuit communicates with the network is a network transmission function.
